(19) United States
(12) Patent Application Publication
(10) Pub. No.: US 2010/0328223 A1
(43) Pub. Date: Dec. 30, 2010

(54) Apparatus and associated methods

(75) Inventors: Mohammad Ali Mockarram-Dorri, Copenhagen (DK); Ralf Wieser, Beimerstetten (DE); Martin Punke, Mittelbiberach (DE)

Correspondence Address: HARRINGTON & SMITH, 4 RESEARCH DRIVE, Suite 202, SHELTON, CT, 06484-6212, US

(73) Assignee: Nokia Corporation

(21) Appl. No.: 12/459,360

(22) Filed: Jun. 30, 2009

(51) Int. Cl. G06F 3/041

(52) U.S. Cl. 345/173

(57) ABSTRACT

Described herein is an apparatus having a first closed configuration and a second open configuration. The apparatus has a user output area configured to be able to provide viewable user output content, and a user input area including a transparent region configured to be able to receive touch user input. The apparatus is configured such that, in the first closed configuration, the transparent region of the user input area is positioned to at least partially overlie and cover the user output area to provide a covered region of the user output area, the transparent region of the user input area allowing the content on the user output area in the covered region to be viewable through the user input area. The apparatus is also configured such that, in the second open configuration, the user input area is positioned to be moved away from the user output area to provide a revealed region of the user output area to allow the content of the user output area in the revealed region to be directly viewable. The user input area is configured to provide for user input in both first and second configurations.

### TECHNICAL FIELD

The present disclosure relates to the field of apparatus, apparatus for electronic devices, associated methods, and computer programs. Certain disclosed aspects/embodiments relate to portable electronic devices, in particular, so-called hand-portable electronic devices which may be hand-held in use (although they may be placed in a cradle in use). Such hand-portable electronic devices include so-called Personal Digital Assistants (PDAs).

The portable electronic devices/apparatus according to one or more disclosed aspects/embodiments may provide one or more audio/text/video communication functions (e.g. tele-communication, video-communication, and/or text transmission (Short Message Service (SMS)/Multimedia Message Service (MMS)/emailing) functions), interactive/non-interactive viewing functions (e.g. web-browsing, navigation, TV/program viewing functions), music recording/playing functions (e.g. MP3 or other format and/or (FM/AM) radio broadcast recording/playing), downloading/sending of data functions, image capture function (e.g. using a (e.g. in-built) digital camera), and gaming functions.

### BACKGROUND

Apparatus/devices such as mobile phones, PDAs, gaming devices, e-book readers, etc typically utilise electronic displays to provide useful information as user content to a user. Other devices such as laptops, personal computers, netbooks, personal entertainment devices, or even cars may utilise electronic displays to provide user content to a user. User content can consist of text, colour/gray-scale images, movies/videos, news/information tickers, etc. These can often be provided via software such as web browsers, e-book reading programs, photo or video editors, etc. The user content provided can typically be changed or varied according to the functionality desired by the user.

Many mobile phones, for example, utilise a single screen/display or single type of screen/display to present all information and user content to a user. Such displays are typically active light emitting screens that continuously emit light to provide content to a user (for example, LCD, TFT, EL, OLED, VFD, SED, FED, PDP, screens, etc). Reflective displays can also be used, (for example, electronic ink displays, electrophoretic displays, electrowet type displays, etc).

In most apparatus/devices lacking a screen that is touch sensitive, a mechanical keypad is typically provided and normally separated from the display. These often take the form of numeric keypads, alphanumeric keypads, or full/half QWERTY keypad (as in the Nokia N97™ ). This allows for user input to be provided to the apparatus/device to control the apparatus and the content provided to the display.

Keypads typically have dedicated functions such as numeric (normal keypad) or alphabetic keys (QWERTY keypad). Despite this, there are many keypads that have multiple modes of operation, in that they can change their provided functionality depending on the needs of the user.

Also, many mobile devices (such as phones and PDAs) use displays that are touch sensitive. These types of displays remove/reduce the need for separate mechanical/physical user input areas such as keypads or keyboards. This allows such devices to be provided with large display areas that can also receive user input provided by a user touching the screen with their finger, or a stylus, or the like.

Alternate types of input functionality can be provided by these touch screens/displays, as they can be configured to display and receive various types of input such as alphabetic, or numeric, etc. They can also be used to provide customised user input areas. The provided functionality can also be changed very rapidly by reconfiguration of the display. These are also known as Changing Graphics Keypads (CGK).

Sometimes these devices have both a mechanical keypad as well as a touch screen. Some of these devices only provide for limited touch functionality via the screen and rely heavily on the mechanical keypad for receiving user input (for example, only a few functions/keys are implemented as “touch keys” in devices like the Nokia 5330™).

However, in an apparatus/device where the touch sensitive display provides for both user output and user input, the areas of the display dedicated to each function can get cramped and cluttered. For example, when the display provides an onscreen keyboard for the entry of text, only the remainder of the display is available for viewing content provided to the user. There is therefore always a compromise in such situations, as when more space is used for user input, the less is available for displaying content (and vice versa).

One solution that the prior art suggests is to provide physically separate mechanical keypads to expand the usable area of the apparatus for user input. Currently there are either separate mechanical keypads (for example, see U.S. Pat. No. 7,048,422). Another solution is to provide a further detachable touch input screen, as described in U.S. Pat. No. 7,109,977. WO 03/079,174 and U.S. Pat. No. 7,403,190 also describe ideas for changeable keypad illuminations.

The Motorola Krave™ touch phone is a flip phone that comprises a transparent touch interface and an active display, the transparent touch interface overlying the active display in a first closed configuration, and being foldably opened away from the display in a second open configuration. In the first configuration the display is viewable through the transparent touch interface. In the second configuration the display is directly viewable as the transparent touch interface is moved away from the display. However, the touch interface is not usable or able to receive touch user input when it is moved away from the display in the second configuration.

LG GD900™ is a touch sensitive phone that comprises a transparent touch interface and an active display. The active display overlies the transparent touch interface in a first closed configuration, and the touch interface is slidable away from the display to be opened into a second open configuration. In the first configuration the display is directly viewable but the touch interface is inaccessible and covered by the display. In the second configuration the display is still directly viewable, but the touch interface is now accessible. This document does not discuss providing a transparent touch interface to overly an active display, such that the display is viewable through the touch interface in the first configuration, and directly viewable in the second configuration.

GB2389696 describes a hybrid display that has active display elements and reflective display elements, the reflective elements being positioned to overlie and to be adjacent to the active element. The underlying active display elements are not viewable through the overlying reflective elements. The document also teaches that the displays provide for the same user information. This document is not directed towards providing touch sensitive user input areas or apparatus that can adopt different physical configurations.

The listing or discussion of a prior-published document or any background in this specification should not necessarily be taken as an acknowledgement that the document or background is part of the state of the art or is common general knowledge. One or more aspects/embodiments of the present disclosure may or may not address one or more of the background issues.

### SUMMARY

In a first aspect, there is provided an apparatus having a first closed configuration and a second open configuration, the apparatus comprising:
a user output area configured to be able to provide viewable user output content; and
a user input area comprising a transparent region configured to be able to receive touch user input, the apparatus being configured such that:
in the first closed configuration, the transparent region of the user input area is positioned to at least partially overlie and cover the user output area to provide a covered region of the user output area, the transparent region of the user input area allowing the content on the user output area in the covered region to be viewable through the user input area; and
in the second open configuration, the user input area is positioned to be moved away from the user output area to provide a revealed region of the user output area to allow the content on the user output area in the revealed region to be directly viewable, the user input area being configured to be able to receive user input in the first and second configurations.

In the first configuration, the transparent user input area overlies the user output area to provide for touch user input to the apparatus. This can provide an apparatus that can effectively act as a touch screen/display type apparatus.

In the second configuration, the transparent user input area is moved away from the user output area to (at least partially) reveal the second display area whilst still being able to receive touch user input. This can provide an apparatus that has a distinct user input area and user output area, the two being moved apart to provide for an increase in area of the apparatus for convenient operation. Specifically, by moving the user input area away and still enabling it to receive user input, a separate user input area is provided that does not interfere with the content to be displayed on the user output area. The user output area can then provide full content across its entire area without being compromised by the user input area.

The apparatus may be configured such that the user input area and user output area can be moved away from one another by one or more of: relative sliding, rotation, folding, or separation. The apparatus can be implemented in a number of different transformable form factors to provide for slide-type apparatus, folding type apparatus, rotatable type apparatus, or even apparatus that can be separated into two parts (input and output areas split into two distinct parts).

The entirety of the user input area may be configured to be transparent to thereby allow the content in the covered region of the user output area to be viewable through the user input area.

The user output area may be an active light emitting display. This display may be selected from the list of: reflective displays, TFT, LCD, EL, LED, OLED, VFD, SED, FED, PDP, and/or OLED.

The user input area may utilise the following types of touch technology: capacitive, resistive, optical, surface acoustic waves, strain, or acoustic pulse recognition.

The apparatus may also comprise haptic elements configured to provide haptic feedback in response to touch user input by the user input area. Whilst physical keypads have a tactile and physical response to being pushed, touch input areas do not. By providing haptic elements, this can allow for physical feedback in response to user input when using touch user input surfaces. These haptic elements may be provided by appropriately sized motors, or the like.

The apparatus may have one or more user input modes each having a set of user input functions associated with the respective mode, the apparatus being configured such that selection of a particular user input mode provides for the associated set of user input functions on the user input area. This allows the input area to be configured/reconfigured to provide for different user input modes and different functions on the same surface. Each of these modes can be suitable for certain types of user input, thus allowing the user to adopt the most suitable type of user input mode for a particular task.

The apparatus may be configured to provide for a first and second user input mode, the apparatus also being configured such that movement of the apparatus into the first configuration causes the selection of the first user input mode to provide for a first set of user input functions on the user input area, and such that movement of the apparatus into the second configuration causes the selection of the second user input mode to provide for a second set of user input functions on the user input area.

In this example, the first configuration is linked with a first mode and the second configuration is linked with a second mode. Upon movement of the apparatus from one mode to the other, the input mode is also changed from one corresponding mode to the other. This allows for easy movement from one user input mode to another by changing the physical configuration of the apparatus. Therefore, appropriate input modes for a particular physical configuration can be linked with that configuration to allow for optimal use and entry of user input.

The selection may be performed by detecting relative movement of the apparatus between the different configurations. For example, the apparatus may comprise additional physical configurations defined by the relative positioning of the user input and output areas. Each configuration may have one or more user input modes associated with it such that relative movement of the two areas causes the selection of the user input mode associated with a given configuration.

The apparatus may also comprise a switch or movement detector that detects this relative movement or movement between different configurations. This switch/detector may be configured to cause the selection of a particular user input mode associated with the detected movement.

By providing a detector it is possible to detect the change in configuration of the apparatus. This detection can be used to control the operation of the apparatus, or it can be used as further input during the operation of the apparatus. The detector may also be configured to detect the relative orientation and/or change in orientation of the apparatus.

The apparatus may further comprise one or more light emitting elements configured to provide visual output indications and provided with the user input area, the set of user input functions provided by a given user input mode being visually indicated by the light emitting elements. These light emitting elements can be used to indicate what user input functions are available to a user at a particular time. In combination with the changeable user input modes, these light emitting elements can provide for a visual reconfiguring of the user input area to clearly identify the nature of the adopted user input mode.

These light emitting elements may be selected from the list of: OLEDs, LEDs, fibre optics, EL, quantum dots (QD), UV light together with phosphor/QDs, and/or backlights.

The light emitting elements may be provided on, within, below, beside and/or around the user input area. One or more of the light emitting elements are associated with particular user input functions.

The set of user input functions may provide for one or more of: QWERTY keyboard input, numerical keypad input, alphanumeric keypad input, gaming input, audio/visual input, navigational input, touch pad input and/or handwriting recognition input. By altering the visual indications provided by the light emitting elements, the overall appearance of the user input area can be changed to suit the particular adopted input mode.

The light emitting elements may also be configured to, when in the first configuration, provide visual indications that correspond to user output content provided by the user output area that is viewable through the transparent region of the user input area. For example, upon being moved into a QWERTY mode, the light emitting elements can provide a corresponding QWERTY keyboard on the input area to direct a user as to what regions of the input area provide for what function.

The apparatus may be configured such that:
in the first closed configuration, the user input area may also be configured to be able to provide viewable user output content; and/or
in the second open configuration, the user output area may also be configured to be able to receive touch user input.

For example, the user input area may also be a transparent touch sensitive display that can also provide for viewable user output content in the first closed configuration. This can be likened to a transparent display overlying another display, thus allowing content of the “second” display (user output area) to be viewable through the first display (user input area).

In another example, the “second” display (user output area) may also be touch sensitive so that it can receive touch input when in the second configuration. This can be likened to providing a substantially increased area for user input when the apparatus is in the second configuration.

The user input area may be configured such that, in the second open configuration, it provides for additional user output content to supplement the content provided by the user output area. This can be used to provide a substantially increased viewing area of the apparatus for displaying content.

The user input area may be configured such that it is only able to receive touch user input. In this example, the input area is a dedicated user input area.

The user output area may be configured such that it only provides for viewable user output content. In this example, the output area is a dedicated user output area.

The apparatus may be configured such that the user input area is able to control the content provided on the user output area. In this example, the user input area is usable to control what is displayed on the output area underlying it or revealed by it by movement to the second configuration.

The apparatus may be configured such that, in the first configuration, the available user input functions on the user input area are displayed on the user output area below. For example, the user output area may be used to highlight or indicate which functions are provided where on the user input area.

The user input area may be configured to have a first optical mode, a second optical mode and a further mirror mode, the apparatus further comprising:
an adjustable output area, the output area being configured to be movable between an optically transparent state, an optically non-transparent state, and an optically reflective state;
the transparent region of the user input area being positioned to at least partially overlie the adjustable output area, the transparent region of the user input area allowing the optical state of the adjustable output area to be viewable through the user input area, the optical state of the adjustable output area thereby defining the optical state of the transparent region of the user input area, wherein the apparatus is configured such that:
in the first optical mode, the adjustable output area is in the transparent state to thereby place the overlapping region of the user input area in an optically transparent optical mode;
in the second optical mode, the adjustable output area is in the non-transparent state to thereby place the overlapping region of the user input area in an optically non-transparent optical mode; and
in the third mirror mode, the adjustable output area is in the reflective state to thereby place both the overlapping region of the user input area in an optically reflective mirror mode.

In the above case, an adjustable output area is provided in addition to the output area mentioned previously. In other embodiments, the output area mentioned previously can be adapted to be the adjustable output area mentioned immediately above.

The user input area may comprises a display element (or adjustable output area), the display element (or adjustable output area) having a transparent state, a non-transparent state, and a mirror state, and being configured to be movable between these states, and wherein the apparatus is configured such that the optical state of the display element (or adjustable output area) can be used to change the optical state of the user input area.

In another aspect, there is provided an apparatus comprising a user input area, the user input area comprising a transparent region configured to be able to receive touch user input, and wherein the apparatus comprises a display element, the display element having a transparent state, a non-transparent state, and a mirror state, and being configured to be movable between these states, wherein the optical state of the display element changes the optical state of the user input area.

By providing the apparatus (or even the user input area) with a further display element, it is possible to change the optical state of the transparent user input area, the state being defined by the optical state of the display element. This can provide additional modes in which the input area is/appears to be transparent, or opaque, or even mirrored. The transparent mode can allow for items to be seen through the input area. The opaque mode can help to contrast the user input area. The mirrored mode can allow a user to use the input area as a mirror. This provides for several advantageous modes all within a single area of the apparatus, thus saving space.

In a further aspect, there is provided an apparatus having a first closed configuration and a second open configuration, the apparatus comprising:
a means for providing user output configured to be able to provide viewable user output content; and
a means for receiving user input comprising a transparent region configured to be able to receive touch user input, the apparatus being configured such that:
in the first closed configuration, the transparent region of the means for receiving user input is positioned to at least partially overlie and cover the means for providing user output to provide a covered region of the means for providing user output, the transparent region of the means for receiving user input allowing the content on the means for providing user output in the covered region to be viewable through the means for receiving user input; and
in the second open configuration, the means for receiving user input is positioned to be moved away from the means for providing user output to provide a revealed region of means for providing user output to allow the content on the means for providing user output in the revealed region to be directly viewable, the means for receiving user input being configured to be able to receive user input in the first and second configurations.

In a further aspect, there is provided a portable electronic device comprising any apparatus mentioned previously.

In a further aspect, there is provided a method of assembling an apparatus, the apparatus having a first closed configuration and a second open configuration, the apparatus comprising:
a user output area configured to be able to provide viewable user output content; and
a user input area comprising a transparent region configured to be able to receive touch user input, the apparatus being configured such that:
in the first closed configuration, the transparent region of the user input area is positioned to at least partially overlie and cover the user output area to provide a covered region of the user output area, the transparent region of the user input area allowing the content on the user output area in the covered region to be viewable through the user input area; and
in the second open configuration, the user input area is positioned to be moved away from the user output area to provide a revealed region of the user output area to allow the content on the user output area in the revealed region to be directly viewable, the user input area being configured to be able to receive user input in the first and second configurations, the method comprising:
assembling the apparatus to allow the user input area, in the first configuration, to be positioned to at least partially overlie and cover the user output area to provide a covered region of the user output area, the transparent region of the user input area allowing the content on the user output area in the covered region to be viewable through the user input area, and to allow for the user input area, in the second configuration, to be positioned to be moved away from the user output area to provide a revealed region of the user output area to allow the content of the user output area in the revealed region to be directly viewable.

In a further aspect, there is provided a computer readable medium comprising code stored thereon, the computer code being configured to, when run on a computer, perform the method of controlling an apparatus, the apparatus having a first closed configuration and a second open configuration, the apparatus comprising:
a user output area configured to be able to provide viewable user output content; and
a user input area comprising a transparent region configured to be able to receive touch user input, the apparatus being configured such that:
in the first closed configuration, the transparent region of the user input area is positioned to at least partially overlie and cover the user output area to provide a covered region of the user output area, the transparent region of the user input area allowing the content on the user output area in the covered region to be viewable through the user input area; and
in the second open configuration, the user input area is positioned to be moved away from the user output area to provide a revealed region of the user output area to allow the content on the user output area in the revealed region to be directly viewable, the user input area being configured to be able to receive user input in the first and second configurations, the method comprising:
controlling the provision of viewable user output content to the user output area; and
controlling the reception of touch user input from the user input area.

The present disclosure includes one or more corresponding aspects, embodiments or features in isolation or in various combinations whether or not specifically stated (including claimed) in that combination or in isolation. Corresponding means for performing one or more of the discussed functions are also within the present disclosure.

Corresponding computer programs for implementing one or more of the methods disclosed are also within the present disclosure and encompassed by one or more of the described embodiments.

The above summary is intended to be merely exemplary and non-limiting.

### BRIEF DESCRIPTION OF THE FIGURES

A description is now given, by way of example only, with reference to the accompanying drawings, in which:

FIG. 1a shows an isometric view of a first closed configuration of an apparatus according to a first embodiment.

FIG. 1b shows an isometric view of a second open configuration of the apparatus of the first embodiment.

FIG. 1c shows an isometric view of the housing of the apparatus together with the comprised aperture.

FIG. 1d shows an isometric view of user output area of the apparatus shown in FIG. 1a.

FIG. 1e shows an isometric view of the user input area of the apparatus shown in FIG. 1a.

FIG. 1f shows a cross section and nature of operation of the first and second displays of the apparatus shown in FIG. 1a.

FIG. 1g shows a side-on illustration of how light emitting elements can be provided in the transparent region of user input area.

FIG. 2 illustrates four different examples of different user input modes provided by the user input area.

FIG. 3 illustrates a further variation of the first embodiment. FIG. 4a shows a front-on illustration of how the optical state of the user input area can be made to be transparent.

FIG. 4b shows a front-on illustration of how the optical state of the user input area can be made to be opaque.

FIG. 4c shows a front-on illustration of how the optical state of the user input area can be made to be reflective/mirrored.

FIG. 5 shows a flowchart illustrating the method of controlling the output area of the apparatus and reception of touch input via the input area as provided by a computer program stored on a computer readable medium.

FIG. 6 shows a flowchart illustrating the method of assembly of the apparatus.

FIG. 7 illustrates schematically a computer readable medium providing a program according to an embodiment of the present invention.

### DESCRIPTION OF SPECIFIC ASPECTS/EMBODIMENTS

In one or more embodiments described herein, there is provided an apparatus having a first closed configuration and a second open configuration. The apparatus comprises a user output area configured to be able to provide viewable user output content, and a user input area comprising a transparent region configured to be able to receive touch user input. The apparatus is configured such that, in the first closed configuration, the transparent region of the user input area is positioned to at least partially overlie and cover the user output area to provide a covered region of the user output area, the transparent region of the user input area allowing the content on the user output area in the covered region to be viewable through the user input area. The apparatus is also configured such that, in the second open configuration, the user input area is positioned to be moved away from the user output area to provide a revealed region of the user output area to allow the content on the user output area in the revealed region to be directly viewable, the user input area being configured to be able to receive touch user input in the first and second configurations.

The apparatus described here has (at least) two configurations: a first closed configuration, and a second open configuration. The transparent region of the user input area overlies the user output area in the first configuration. The transparency allows the content on the user output area to be viewable through the user input area, despite the input area being positioned to cover the output area. This can allow for continued operation of the apparatus and viewing of content even in a closed state. Advantageously, this provides for user input and continued viewing of user content in a compact form whilst being closed.

In the second configuration, the input area is moved away from the user output area so as to reveal a region of the output area. This allows for content on this revealed region to be directly viewable now that it has been revealed. The moving apart of the input and output areas can also provide an apparatus with an increased area for use, in that the input area is still accessible, whilst also revealing a further area for use in the revealed region of the user output area. This particular apparatus configuration therefore has an increased area that can be used for separate input and content viewing, rather than the overlapping areas in the closed configuration discussed above. Advantageously, this provides for separate user input and viewing of user content, as well as helping to alleviate the issue of the user input area obscuring, detracting, or compromising the viewing of user content (an issue discussed previously).

In short, this apparatus allows for (at least) two distinct configurations that can provide different advantages depending on the adopted configuration. The apparatus can provide a compact form factor with both input and output functionality in substantially the same area (due to the stacked input/output areas) in a first configuration, and it can provide an expanded form factor with separate areas for providing input and output functionality, (due to the input/output areas being moved apart).

In a variation of this embodiment, there is provided an apparatus as in the first embodiment, wherein the user input area comprises a display element. The display element is configured to have a transparent state, a non-transparent state, and a mirror state. The display element is also configured to be movable between these states. The optical state of the display element changes the optical state of the user input area.

In this variation, the user input area has a display element that can be made to be optically transparent, optically non-transparent (for example, translucent or opaque), or to be mirrored. As the user input area is always transparent, the optical state of the display element is always visible, and therefore the optical state of the display element also defines the optical state of the user input area. For example, when the display element is moved to the non-transparent state, the input area is also observed to be (or become) non-transparent. Also, when the display element is moved to the mirrored state, the input area is also observed to become mirrored. Finally, whenever the display element is set to be optically transparent, the input area also appears to be transparent.

This arrangement allows the display element to control the optical state of the input area to provide for different modes, in that the non-transparent state can act to contrast the input area (like a backing area), or in the mirrored state the input area can act like a mirror.

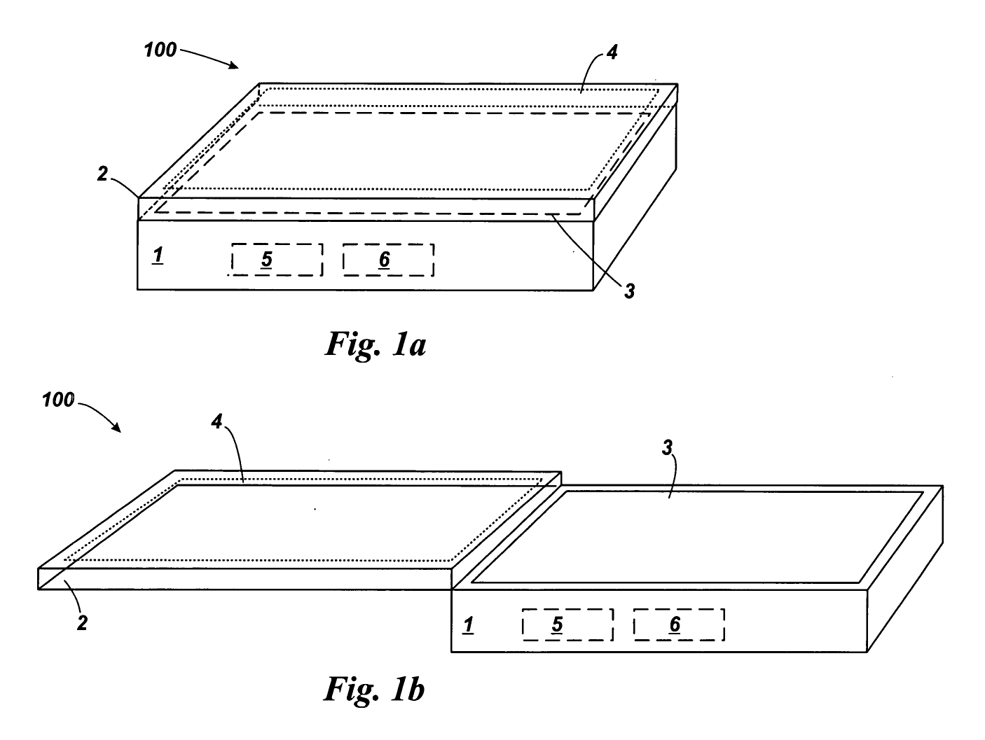

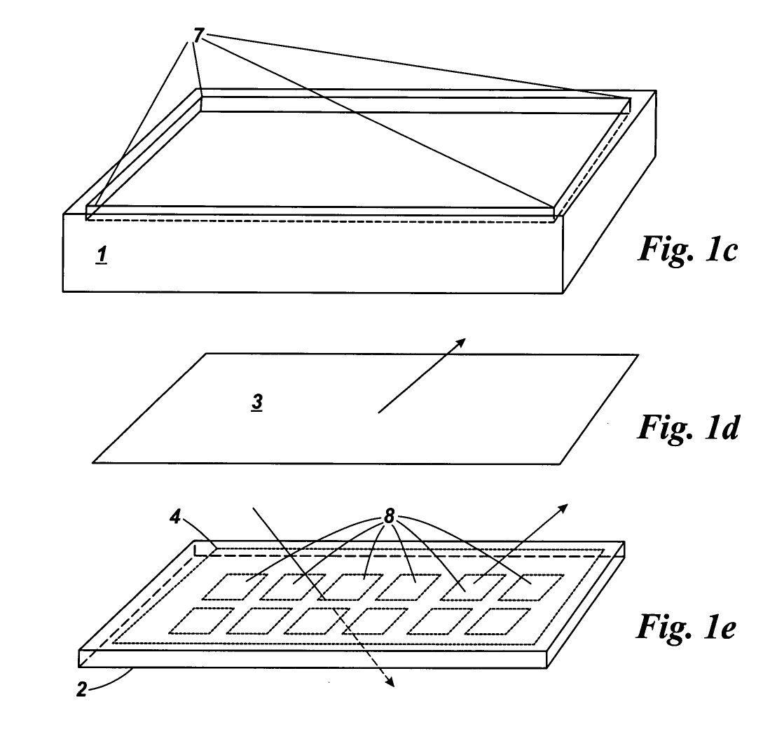

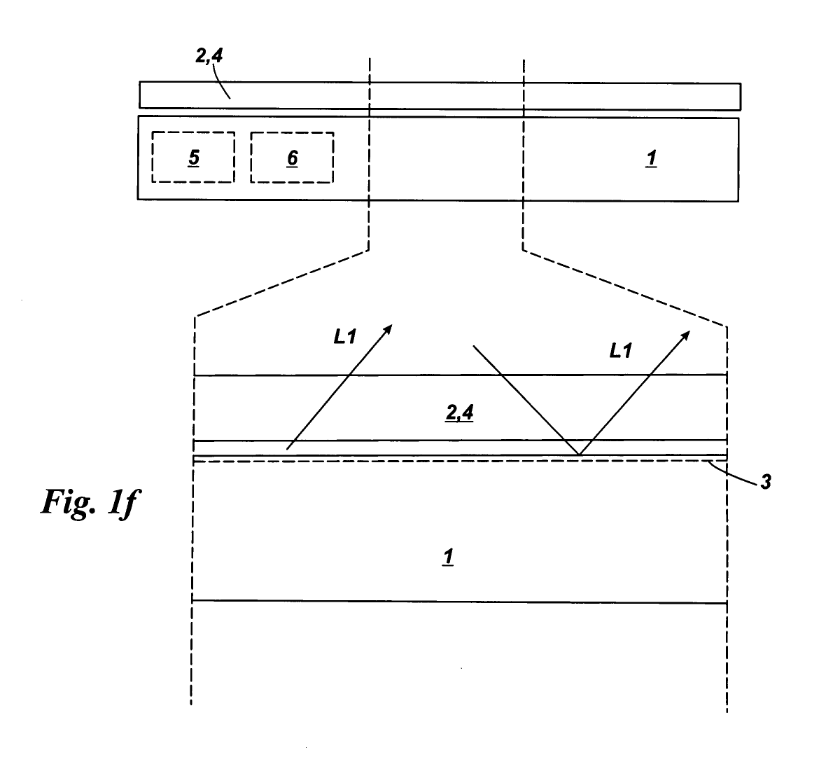

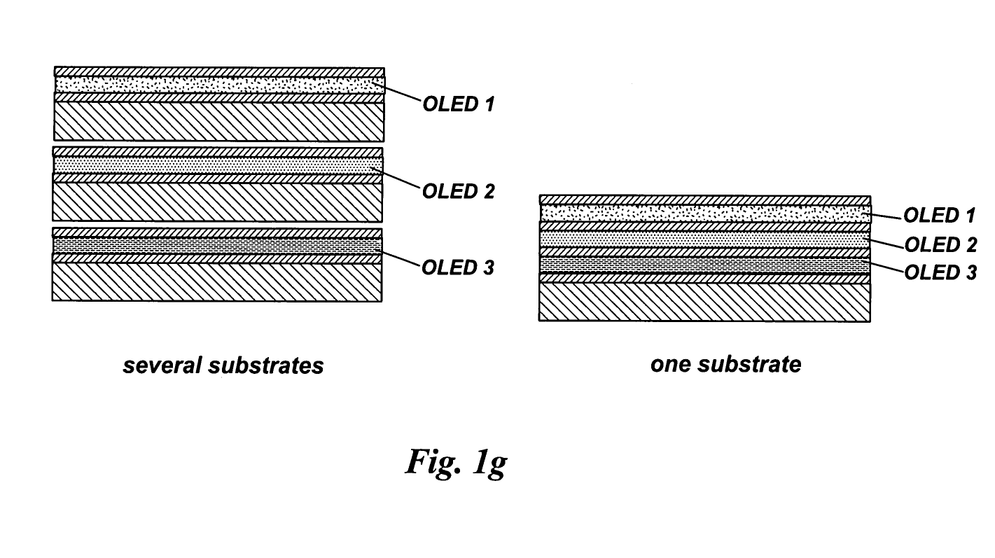

We will now describe the first embodiment of the invention according to FIGS. 1a-1g.

In a first embodiment, as shown in FIGS. 1a & 1b, there is provided an apparatus 100. The apparatus 100 comprises a first housing 1, a second housing 2, a display 3 (e.g. a user output area), a touch panel 4 (e.g. a user input area), a processor 5 and a power supply 6.

We will now describe the first housing with reference to FIG. 1c.

The first housing 1 is a cuboidal casing formed via injection moulding of thermoset resin. The first housing 1 is configured to be cuboidal in shape, specifically being shaped and dimensioned to be slightly longer and wider than the dimensions of the display 3 (relative to FIG. 1a), and also to be substantially deeper than the height of the display 3 (also relative to FIG. 1a). In other embodiments, the housing 1 may be formed from other types of moldable or injection moldable plastics, or may even be formed from metal, wood, or any other suitable material. In other embodiments, other shapes can be used for the housing 1 (or any other housings).

The first housing 1 has an aperture 7 in the top face of the housing 1. The aperture 7 is configured to be shaped and dimensioned to be complementary to the display 3. This is so that the aperture 7 is capable of receiving and housing the display 3 when the apparatus 100 is assembled. Specifically, the aperture 7 in the top face of the housing 1 has a rectangular opening whose dimensions match those of the display 3, and a depth that allows the display 3 to be placed within the aperture 7.

The aperture 7 also has small protrusions/rims (not shown) on the walls of the aperture 7 configured to be able to receive the display 3. There is a rim that runs all the way around the walls of the cavity near the bottom of the cavity. This is so that, during assembly, the display 3 can be inserted into the aperture 7 so as to come to rest on the rim. The rim is also positioned so that the display 3 is flush with the top face of the housing 1 when mated with the rim.

The skilled person will appreciate that there are other possible ways to configure the aperture to receive the display 3. For example, the rim may just be spaced out protrusions/lugs rather than a complete rim. Other variations may also allow for the display 3 to be positioned such that it is sunk below the top face of the housing 1 when assembled into the first housing 1.

The first housing 1 also comprises additional internal cavities (not shown) dimensioned to receive the processor 5 and the power supply 6. This is so that the processor 5 and power supply 6 can be housed within the housing 1 of the apparatus 100. The housing also comprises connection channels (not shown) leading from the aperture 7 and the top face of the housing 1 to these cavities. This is so that the electrical connections of the second housing 2 (together with the touch panel 4) and display 3 can be connected to the processor 5 and the power supply 6 once the apparatus 100 is assembled.

The first housing 1 comprises sliding rails (not shown) positioned/formed on its top face. The rails are configured to be able to slidably mate with complementary grooves (not shown) comprised by the second housing 2 (discussed later). This sliding rail/groove arrangement has not been shown in the figures or described in detail, as such arrangements are well known in the art, (for example, see known slide-type mobile phones). This arrangement is merely described for the purpose of understanding that the first and second parts/housings (/user input/output areas) are movable relative to one another such that they can be positioned away from each other as shown in the figures.

The rails are dimensioned to be of similar dimensions to the grooves of the second housing 2 (described later) to allow for sliding. The rails and grooves are also integrally formed from the same respective materials as the first and second housings 1, 2. The rails and the grooves are also polished so as to have a low co-efficient of friction against one another. This is to allow for sliding of the first and second housings 1, 2 relative to each other once they are assembled.

The sliding rails each comprise respective defined ends that are configured to mate with corresponding defined ends of the complementary grooves. This is to allow the sliding movement of the first housing 1 relative to the second housing to be terminated upon inter-engagement of the ends of the rails with the ends of the grooves. The ends are positioned such that a first point of termination of sliding would occur when the second housing 2 is positioned to completely overlie the first housing 1 (as per FIG. 1a), and such that a second point of termination would occur when the second housing 2 is positioned to have the right end of the second housing 1 just overlying the left end of the first housing 1 (relative to FIGS. 1a & 1b, and as per FIG. 1b).

We will now describe the display 3 (a user output area) with reference to FIG. 1d. The display 3 is an active light emitting display. In this embodiment it is a full colour LCD screen. As with most active light emitting displays, the display 3 is configured to emit light in accordance with the user content it is intended to provide. This light is then observed by a user and interpreted as user content displayed by the apparatus on this display 3.

The display 3 is capable of actively displaying coloured user content and is also provided with a backlight (not shown) that enables its displayed content to be emitted as light to a user. In this embodiment the display 3 is an LCD screen, but in other embodiments it may be a TFT screen, LED screen, OLED screen, etc, or any other type of active display (for example, any one or more of LCD, TFT, EL, OLED, VFD, SED, FED and/or PDP screens). In some embodiments, the display 3 may even be a reflective display, such as an electrophoretic or electrowet type display. Alternative display types suitable for providing user content are well known in the art.

The display 3 also comprises electrical connections (not shown) that are suitable for electrically connecting the display 3 to the processor 5 and power supply 6. In this embodiment these electrical connections are conductive wires, but in other embodiments they can be conductive tracks, printed wiring boards (PWB), printed circuit boards (PCB), or they may even be wirelessly connected to the processor (Wi-Fi, Bluetooth™, etc).

In this embodiment, the display 3 is rectangular in shape and very thin (on the order of micrometers to millimeters) so as to match the shape and dimensions of the aperture 7 of the first housing 1. The shape of the display 3 also dictates the shape and dimensions of the aperture 7, at least in this embodiment (it may, of course, be the other way round in other embodiments). The skilled person will appreciate that in other embodiments the display 3 may be a variety of other shapes and of different dimensions (for example, length width and depth, also in area). For example, the display 3 may be circular, elliptical, triangular, square, polygonal, or even some other irregular shape.

We will now describe the second housing 2 and touch panel 4 with reference to FIG. 1d.

The second housing 2 is a flat sheet of transparent polycarbonate that is shaped to be rectangular, and shaped in area to match the first housing 1 such that it completely overlies and exactly matches the shape and dimensions of the top face of the first housing 1 in the first configuration when the apparatus 100 is assembled.

In this embodiment, the second housing 2 is made of transparent polycarbonate. However, in other embodiments, the skilled person will appreciate that other transparent materials can be used, such as acrylic, PVC, PE, PPE, glass, etc. The transparency is important so as to allow light to reach the display 3 that will be underneath the second housing 2 (described below). In other embodiments it will be appreciated by the skilled person that only portions of the second housing 4 may be transparent, or that the housing 2 may be translucent to some extent, or that it may have some combination of transparent, translucent and opaque regions.

The skilled person will appreciate that, in other embodiments, the second housing 2 may be a variety of other shapes and dimensions (for example, length width and depth, also in area) other than rectangular, and may not necessarily exactly match the shape and dimensions of the first housing 1. For example, the second housing 2 may be circular, elliptical, triangular, square, polygonal, or even some other irregular shape whilst the first housing 1 may be some other shape.

As mentioned previously in reference to the sliding arrangement of the first and second housings 1, 2, the second housing 2 comprises complementary grooves (not shown) positioned/formed on the bottom face of the second housing 2. These grooves are dimensioned so as to be able to mate with the corresponding rails of the first housing 1 once the apparatus 100 is assembled. The grooves are integrally formed from the same material as the second housing 2 and are polished so as to allow for easy sliding of second housing 2 relative to the first housing 1 once the apparatus 100 has been assembled. The grooves also have defined ends configured to be able to mate with the respective defined ends of the corresponding rails. These ends mate with the ends of the corresponding rails in the manner discussed previously in relation to points of sliding termination, to thereby define the first closed configuration and the second open configuration.

The touch panel 4 (a user input area) is a capacitive touch sensitive panel that is to be integrated (for example, integrally molded) with the second housing 2 during manufacture/assembly of the apparatus 100. The manufacture and assembly of such touch sensitive panels is well known in the art. The skilled person will also appreciate that other types of touch technology can be used instead (such as resistive, optical, surface acoustic wave, strain, acoustic pulse recognition, or even an OLED with integrated capacitive touch functionality) or in combination with the capacitive touch technology.

In this embodiment, the entire touch panel 4 is transparent. As the whole touch panel 4 (as well as the entire second housing 2 that it is integrated with) is transparent, light can pass straight through the touch panel 4. This is important so as to allow light to reach the display 3 that will be underneath the touch panel 4 (described below), at least when the apparatus 100 is in the first configuration. In other embodiments it will be appreciated by the skilled person that only portions of the touch panel 4 will be transparent, or that it may be translucent to some extent, or that it may have some combination of transparent, translucent and opaque regions.

In this embodiment, the touch panel 4 is rectangular in shape and has a depth/thickness of the order of micrometres to millimetres. It should be noted that (at least in this embodiment), the touch panel 4 is configured to be shaped and dimensioned to be the same shape and area as the display 3, rather than to be the same dimensions as the entirety of the second housing 2. This is so that, when the apparatus is assembled, the touch panel 4 can be positioned (in the first configuration) so as to overlie the display 3 completely such that they provide what can be considered to be a single touch sensitive display area from a user's perspective in the first configuration), and so as not to have any overhanging portions.

In other embodiments described herein it will be appreciated by the skilled person that the touch panel 4 may be shaped and dimensioned differently to the display 3 such that it is larger/smaller than the display 3, or even to be a different shape to the display 3 (or vice versa). For example, the touch panel 4 and display 3 may be relatively configured such that the display 3 is only partially covered by the area of the touch panel 4, or even such that the touch panel 4 is substantially larger than the display 3 and can cover the entirety of the display 3.

The touch panel 4 also comprises light emitting elements 8. These light emitting elements 8 are, in this embodiment, layered Organic Light Emitting Diodes (OLEDs) that are disposed within the touch panel 4. These are capable of actively emitting light when activated. These can be manufactured to be substantially invisible within an apparatus. These will be discussed in more detail later.

Of course, the skilled person will appreciate that other types of light emitting elements may be used. For example, fibre optic technology together with a light source may be used in conjunction with etchings/markings on the touch panel to thereby illuminate pre-marked areas of the touch panel 4. In another example, the markings may already be provided on the surface of the second housing 2 instead, or they may be user affixable (for example, replacement keypad coverings). In any case, the OLEDs are just one example of light emitting elements 8 that can be used to provide for visual indications on the touch panel 4/second housing 2. In still other embodiments, reflective elements may be used instead (this may be done with or without a backlight), or in some embodiments no light emitting elements may be provided.

The touch panel 4 also comprises electrical connections (not shown) that are suitable for electrically connecting the touch panel 4 and the comprised light emitting elements 8 to the processor 5 and power supply 6. In this embodiment these electrical connections are conductive wires, but in other embodiments they can be conductive tracks, printed wiring boards (PWB), printed circuit boards (PCB), or may even be wirelessly connected to the processor (Wi-Fi, Bluetooth™, etc). In another embodiment, the second housing 2/touch panel 4 assembly may even comprise (or be connectable to) its own processor and/or power supply (not shown).

The processor 5 is, in this embodiment, an Application Specific Integrated Circuit (ASIC). This is an integrated circuit that is tailored to be suitable for the task of providing content to the display 3 and to receive user input from the touch panel 4 via the electrical connections of the display 3 and touch panel 4 to be connected to the processor. The processor 5 also comprises its own electrical connections for connection to the power supply 6. In other embodiments, the processor 5 may actually be a multipurpose processor that is capable of performing many other tasks, or it may be just one processing chip of many within the apparatus 100.

The power supply 6 is an internal rechargeable battery. In this embodiment the battery is a rechargeable type battery (such as a NIMH battery or other rechargeable types), but in other embodiments it may be a normal non-rechargeable battery (for example an alkaline battery) or the like, or even a fuel cell. In this embodiment, the power supply 6 also comprises power connections (not shown) that enable the battery to be connected to an external power source (not shown) for recharging the battery. In other embodiments the battery may in fact be removable or replaceable.

It will be appreciated by the skilled person that, in further embodiments, other types of power supply may be utilised to provide power to the apparatus. For example, the power supply 6 may in fact just be power connections to enable the apparatus to be connected to an external power source such as a wall socket or USB cable for external powering of the apparatus.

We will now describe the assembly of the apparatus 100 of this embodiment. The assembled apparatus is depicted in FIGS. 1a & 1b.

It should be noted that, prior to assembly, the first and second housings 1, 2 are formed by injection molding in this embodiment. In other embodiments, the first and second housings 1, 2 are prefabricated, or cut from blanks, and/or glued together to form unitary first and second housings 1, 2. In this embodiment, during injection molding of the second housing 2, the touch panel 4 is integrally formed within the second housing 2.

The processor 5 and power supply 6 are first installed into their corresponding cavities within the housing 1. This is to ensure that, when the display 3 is assembled into the housing 1 and the second housing 2/touch panel 4 is assembled with the apparatus 100, they can be connected to the pre-installed processor 5 and power supply 6 via their comprised electrical connections.

The display 3 is placed into the aperture 7 of the housing 1 to mate with the rim of the aperture 7. The display 3 is then connected to the processor 5 and the power supply 6 via its comprised electrical connections. This allows the processor 5 to control the user content provided by the display 3 and also enables the power supply 6 to supply the necessary power to the display 3 to allow for said content to be displayed and controlled by the processor 5. The display 3 is then glued into place along the rim of the aperture 7.

The second housing 2 is then slidably coupled with the first 1 housing via the corresponding rails and grooves arrangement. The electronic components of the second housing 2 (the touch panel 4, light emitting elements 8, etc) are then connected to the processor 5 and the power supply 6 via the comprised electrical connections. This allows the processor 5 to control the user functionality provided by the touch panel as well as the visual indications provided by the light emitting elements 8. This also enables the power supply 6 to supply the necessary power to the second housing 2 to provide the power necessary to operate the touch panel 4 and enable the light emitting elements 8 to emit light.

We will now describe the functionality of this embodiment with reference to FIGS. 1a, 1b, 1e & 1f.

The sliding arrangement of the rails and grooves of the apparatus 100 allows the second housing 2 to be positioned to completely overlie the first housing 1 at the first point of sliding termination. This defines a first configuration in which the apparatus 100 is in a substantially monoblock form factor, and wherein the touch panel 4 of the second housing 2 matches up with the display 3 of the first housing 1. This means that the touch panel 4 will completely and precisely overlie the display 3 in the first configuration. This is depicted in FIG. 1a.

In this configuration the transparent touch panel 4/second housing 2 completely overlies the display 3. As can be seen in FIG. 1f, this still allows for user content provided by the display 3 to be viewed through the second housing 2. The light emitted by the display 3 (indicated by light ray L1) is able to pass uninterrupted through the transparent second housing 2 to be viewed by a user. In variations where a reflective display is used, light is also able to pass through the transparent second housing 2 to reach and reflect off of the reflective display 3, back through the transparent second housing 2 to be viewed by a user.

In the first configuration, the touch panel 4 can be used to control the apparatus and thereby influence the content provided on the display 3. For example, the display 3 may be providing content related to a mail program. The touch panel 4 may allow a user to interact directly with the content displayed on the display 3, for example, selecting a mail item in a list provided on the display 3 will cause the processor 5 to recognise the selection and change the displayed user content to that of the selected mail item.

The sliding arrangement of the apparatus 100 also allows the second housing 2 to be slidably moved so as to be positioned away from the first housing 1 such that the right end (relative to the figures) of the second housing 2 just overlies the left end of the first housing 1 at the above-described second point of sliding termination. This is shown in FIG. 1b. This defines a second configuration in which the touch panel 4 and display 3 are no longer overlying or overlapping, but instead the display 3 and touch panel 4 are separated, leaving the display 3 exposed and available for direct viewing by a user. It should be noted that the display 3 is no longer only viewable through the first display, but is directly viewable in this configuration. This is depicted in FIG. 1b.

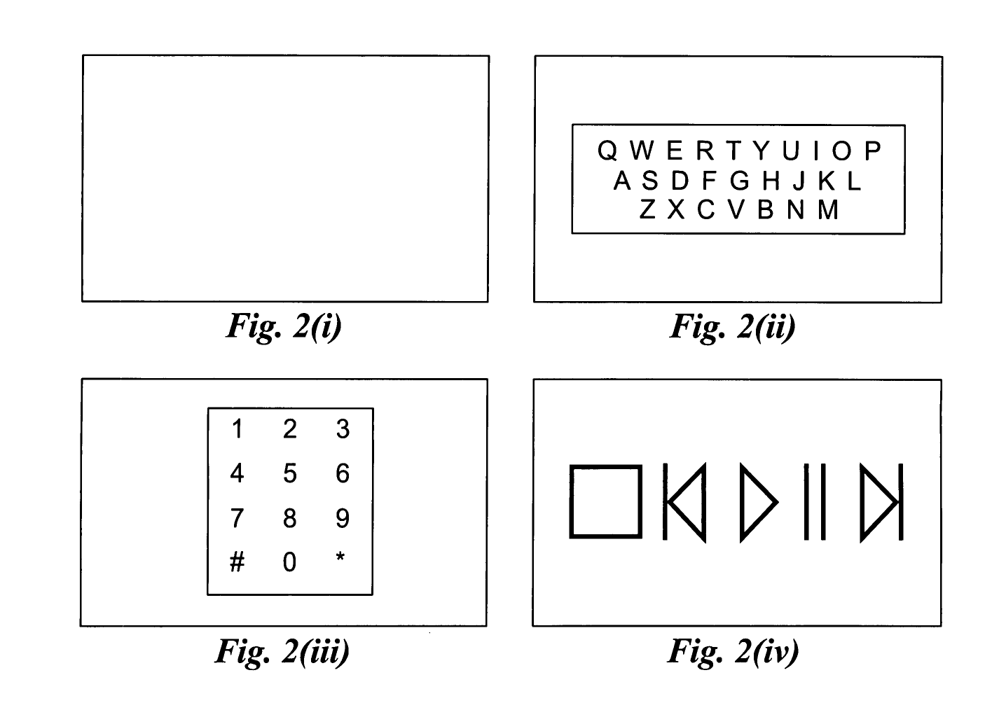

In this second configuration, the touch panel 4 can be used as a substantially separate user input area for controlling the apparatus 100. By doing this, it is able to influence the content provided on the display 3. The light emitting elements 8 can be used to indicate what functions are provided by the touch panel 4 when in the second configuration. This will be discussed later in more detail with reference to FIG. 2.

By allowing for such (in this case) a slidably movable arrangement, the apparatus 100 is able to be moved from a first configuration, in which it provides what can be considered to be a single area for output and input for a user, to a second configuration in which there are substantially separate areas for user output and user input.

By providing for this second configuration, the apparatus 100 can provide for additional functionality. For example, in one embodiment, the display 3 could provide for full size animated images on its display area, and the touch panel 4 could provide for user input without interfering with the content displayed by the display 3.

In another embodiment, the touch panel may also be configured to be a transparent LCD touch screen, therefore also being capable of providing user content and not just touch user input. The display 3 and touch panel 4 could then be combined to provide for an increased display area in the second configuration, providing continuous content that extends across both screens.

In this embodiment, the first and second housings 1, 2 are slidably movable relative to one another along a single axis and in one direction. The skilled person will appreciate that, in other embodiments, the housings 1, 2 may be slidably movable in more than one direction. The skilled person will also appreciate that the nature of the movement of the apparatus is not restricted purely to lateral sliding movement. In fact, the two housings may be rotatably movable relative to each other, tiltable relative to each other, foldable relative to each other, or they even be separated into two distinct housings.

In such embodiments, the two housings 1, 2 may communicate with each other via wired communication (as per the first and second embodiments) or via wireless communication in any of these variations. For example, the two housings may be separated into distinct separate parts provided for separated user input and user output parts. In such an embodiment, they may be configured to communicate with each other wirelessly.

Also, in this embodiment, the first and second housings 1, 2 are physically moved from one configuration to another by a user. In other embodiments, they may be mechanically moved from one configuration to another, for example via spring mechanisms, or rack and pinion and arrangements, or by motorised mechanisms.

Furthermore, whilst there are only two configurations mentioned in this embodiment, the skilled person will appreciate that there may be other embodiments in which the apparatus can adopt more than two configurations, in which the first and second housings 1, 2 are repositioned relative to one another. In variations of this embodiment, the sliding rail/groove arrangement may comprise mateable detents that allow for further configurations between the points of sliding termination, these additional configurations being defined by predetermined positioning of the two housings 1, 2 relative to one another via the mating of the provided detents.

In still further embodiments, the first and second housings 1, 2 may even be continuously movable between different relative positions, to thereby provide an ‘infinite’ number of configurations.

Furthermore, whilst only two housings have been described in this embodiment, the skilled person will appreciate that this concept may be applied to apparatus/devices having a plurality of housing parts. For example, the transparent touch panel 4/second housing 2 may span over two (or more) housings having distinct displays. In another example, there may be two (or more) transparent touch panels/upper housings that are arranged to span over a larger first housing, or they may even be arranged to be stacked one on top of the other.

We will now describe the light emitting elements 8 in combination with the transparent touch panel 4/second housing 2 in more detail (with reference to FIG. 1g).

As the touch panel 4 is transparent, it does not have distinctive markings indicating the functionality each region provides. This is dissimilar to mechanical/physical keypads which have distinct buttons that are used to provide for user input. However, without distinctive markings it can be difficult for a user to know or appreciate what user functionality is provided by a given user interface, or even what parts of the user interface will provide for a particular function. It is therefore useful for the touch panel 4 to have these active light emitting elements 8 to indicate which areas of the touch panel provide what functions.

In the above embodiment, the light emitting elements 8 are OLEDs, but in other embodiments they may be LEDs or any of the abovementioned technologies that can be used for providing light emission, or they may simply be markings on the surface of the touch panel 4 rather than light emitting elements 8 (for example, reflective elements such as electrophoretic or electrochrome/electrochromic type elements).

FIG. 1g shows how these OLEDs may be built up on the touch panel 4/second housing 2 in order to provide for the above features. It is well known in the art how to create OLEDs, therefore we have not discussed the manufacturing of OLEDs in detail.

In the first example (left), Red (R), Blue (B) and Green (G) OLEDs are layered on and between separate individual substrates that are deposited/sandwiched together to build/form the second housing 2/touch panel 4. This side-on view shows that there are three layers of the three primary (physics) colours. This means that the three overlaid elements 8 can be independently controlled to illuminate or visually indicate a region of the touch panel 4 with any desired colour. This would be controlled by the processor 5 in response to any number of possible user commands.

In the second example, the same three colour OLEDs are layered one on top of the other on a single substrate involved in forming the second housing 2.

By building up stacked arrays of these elements, it is possible to provide a customised array of full colour light emitting elements. It is also possible to simply use one colour, two colours, or more than two colours in a given arrangement. It is also possible to simply provide specific logos/symbols/light emitting markings on the touch panel 4, rather than providing effectively providing a colour display of OLEDs on this touch panel 4. Again, simply by providing parts of the touch panel 4 with controllable light emitting elements such as OLEDs, it is possible to provide controlled illumination of particular regions of the touch panel 4 to indicate available user functionality.

Furthermore, it should also be pointed out that the nature of OLED technology means that touch sensitivity can be provided on an area that already has an OLED device. For example, by providing an electrode layer on top of the OLED element (for example, an indium tin oxide electrode layer together with special driver electronics), it is possible to cause the OLED itself to be sensitive to touch input. This advantage can be utilised, in some embodiments, by providing a touch panel 4 that is entirely made of OLED elements and, in conjunction with an electrode layer, can thereby provide for both touch input functionality as well as light emitting functionality as discussed above. It should be noted that in some of these embodiments, the electrode layer is actually part of the OLED assembly, and not merely a further layer provided on top of a pre-existing OLED assembly.

The reason for this will become more apparent as we discuss FIG. 2.

As previously mentioned, the transparent touch panel 4 in this embodiment lacks any distinct physical buttons or distinct markings (see FIG. 2(i) for an illustration of this effectively ‘blank’ user input area). Unless there is physical etching or marking of the panel 4/second housing 2, there would be no clear visual indications of what region of the touch panel 4 provides what function. Also, whilst physical etching or marking is a simple way to address this, it does not provide for a versatile user interface, as the functionality of the interface would likely be restricted to the type or nature of the markings on the touch panel 4.

The light emitting elements 8 allow for an advantageous solution to this problem. These elements 8 can be built up on the touch panel 4 to effectively provide for a transparent display that can flexibly indicate the changing functionality of the input area on the touch panel 4.

For example, FIG. 2(ii) illustrates a possible input mode of the apparatus 100 where the touch panel 4 is providing for QWERTY keyboard input. The OLEDs are then activated and controlled to illuminate in a pattern that indicates the nature of the input mode. This is not merely informing the user that the touch panel 4 is presently configured to receive QWERTY type text input, but it also informs the user visually as to which regions of the touch panel 4 are corresponding to which function/feature of the provided interface. The elements 8 provide a visual representation of the touch input mode adopted by the touch panel.

FIG. 2(iii) illustrates another example where the input mode is a numeric keypad. The OLEDs can then be activated and controlled in a different way to provide a visual indicator as to the new adopted user input mode.

FIG. 2(iv) provides yet another example, where the touch panel 4 is configured to provide for audio/video input controls.

The processor 5 is configured to control the functions/input functionality provided by the touch panel 4, and is also configured to operate the light emitting elements 8 in accordance with the adopted functions.

These particular illuminated input types are provided in the second configuration (at least in this embodiment). Such illumination is preferably implemented only in the second configuration so as not to interfere with the viewing of content on the display 3 in the first configuration when the touch panel 4 overlies the display 3. However, in some embodiments the light emitting elements 8 may also be active in the first configuration to complement the output/functionality provided by the display 3. For example, they may be used to further enhance the light emitting aspect of the display 3 to highlight a particular area of the display when presenting a particular piece of user content, or to direct a user to particular region of the display 3 or touch panel 4 for operation of the device (for example, for teaching functionality of a particular mode) or for viewing something important (for example, flashing of the light emitting elements over a message icon to draw a user's attention to a received message). Such localised emission of light is difficult to do with only one display 3 and known backlights, the light emitting elements 8 on the touch panel 4 in the first configuration can alleviate this issue.

In a further embodiment (not shown), the second housing/touch panel is actually a transparent active light emitting display as well as being touch sensitive (such as an LCD, TFT, OLED display, etc). Also, the display of the first housing is also configured to be touch sensitive. In this embodiment, the apparatus is configured to be capable of switching the user input area and user output area, such that the second housing/touch panel is capable of displaying user content, whilst the display of the first housing is capable of receiving touch user input. In variations of this embodiment, the touch user input received by the display can be used to control the user content provided on the second housing/touch panel. In another variation of this embodiment, the touch panel is now actually only a transparent display for providing for user output, and the display 3 is now only a touch sensitive region for receiving user input. In essence, the functionality of each part is now swapped around, the first housing thereby providing an area for receiving user input and the second housing thereby providing an area for providing user output.

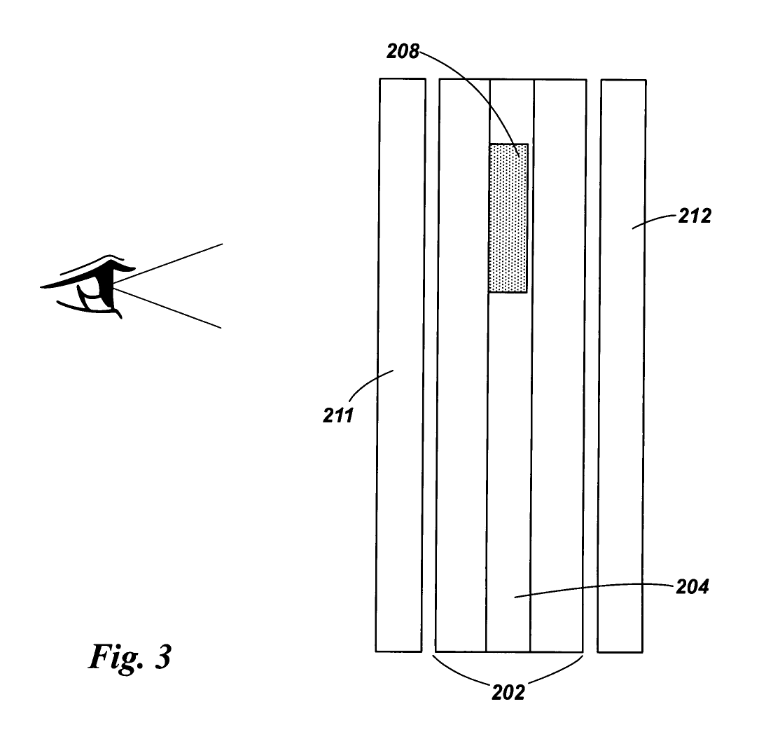

We will now describe a second aspect/embodiment of the invention with reference to FIG. 3. FIG. 3 illustrates a second embodiment that is a further variation of the first embodiment. It will be appreciated that this variation can be implemented separately from the first embodiment, in that any apparatus with a transparent user input area (or a transparent region of a user input area) can provide the described functionality. However, for ease of understanding, we will describe this embodiment by building on the first embodiment.

The transparent second housing 202 further comprises a display element. This display element is provided by two component layers: liquid crystal layer 211, and backing display 212.

The liquid crystal layer 211 is a polymer dispersal liquid crystal layer. This is capable is being moved from an optically transparent state (as per the transparent second housing 2/touch panel 4 arrangement) to a mirrored state in which it provides a mirrored surface on which incoming incident light can be reflected. The skilled person will appreciate that in other embodiments this liquid crystal layer 211 may be provided by some other material, such as a polymer network liquid crystal layer. Any material that can be moved from an optically transparent state to a mirrored state is suitable for this layer.

The liquid crystal layer 211 is shaped and dimensioned to exactly match the shape and dimensions of the second housing 202. This is to ensure that, upon assembly of the apparatus 200, the layer 211 completely and exactly covers the entirety of the front face of the transparent second housing 202.

The skilled person will appreciate that in other embodiments the liquid crystal layer 211 may be a variety of other shapes and of different dimensions (for example, length width and depth, also in area). For example, the layer 211 may be circular, elliptical, triangular, square, polygonal, or even some other irregular shape, and may not necessarily match the transparent second housing 202.

The liquid crystal layer 211 also comprises electrical connections. (not shown) that are able to be connected to a processor and power supply for control of the layer 211. In this embodiment the layer 211 is to be connected to processor 205 and power supply 206, but in other embodiments another processor or power supply may be connectable to the layer 211.

In this embodiment these electrical connections are conductive wires located at the top most edge of the layer 211, but in other embodiments they can be conductive tracks, printed wiring boards (PWB), printed circuit boards (PCB), or they may even be wirelessly connected (Wi-Fi, Bluetooth™, etc).

The backing display 212 is an electrochrome display that is capable of being moved from a transparent state to an opaque state in which light can no longer pass directly through the display. In other embodiments, the electrochrome backing display 212 may be movable from a transparent state to a translucent state (i.e. a less transparent state), or from a translucent state to an opaque or more opaque state. The display 212 may even be movable between a plurality of different optical states (for example, transparent to translucent to opaque). In this embodiment the backing display 212 is an electrochrome display, however the skilled person will appreciate that any display that is capable of being moved from a transparent to a non-transparent optical state may be suitable for use as the backing display 212.

The backing display 212 is shaped and dimensioned to exactly match the shape and dimensions of the second housing 202. This is to ensure that, upon assembly of the apparatus 200, the backing display 212 completely and exactly backs the entirety of the transparent second housing 202.

Again, the skilled person will appreciate that in other embodiments the backing display 212 may be a variety of other shapes and of different dimensions (for example, length width and depth, also in area). For example, the display 212 may be circular, elliptical, triangular, square, polygonal, or even some other irregular shape, and may not necessarily match the transparent second housing 202.

The backing display 212 also comprises electrical connections (not shown) located at the top most edge of the display 212 that are able to be connected to a processor and power supply for control of the display 212. In this embodiment the display 212 is to be connected to processor 205 and power supply 206, but in other embodiments another processor or power supply may be connectable to the display 212.

In this embodiment these electrical connections are conductive wires, but in other embodiments they can be conductive tracks, printed wiring boards (PWB), printed circuit boards (PCB), or they may even be wirelessly connected (Wi-Fi, Bluetooth™, etc).

We will now describe the assembly of this embodiment.

The front of the second housing 202/touch panel 204 is defined by the face that is to be presented to a user and used by the user for touch input. In FIG. 3, the front face is the side opposite the user's eye.

The backing display 212 is mounted to the back face of the second housing 202 so as to completely overlie and back the second housing 202 exactly. In this embodiment, the display 212 is attached using transparent resin that sets so as to be optically transparent without distorting light passing through the whole assembly. In other embodiments it may be attached using alternate fixing mechanisms, such as other glue/resin types, screws/bolts, or it may even be integrally formed/molded with the second housing 202.

The liquid crystal layer 211 is mounted to the front face of the second housing so as to completely overlie and cover the front face of the second housing 202 exactly. In this embodiment, the layer 211 is attached using transparent resin, however alternate methods of fixing may be used (see the discussion of alternate methods for attaching the display 212 to the second housing 202 above).

The three layers are therefore combined to form an assembly that is (from front to back) formed as the liquid crystal layer 211, the second housing 202/touch panel 204, and backing display 212.

It should be noted that whilst in this embodiment the layers (liquid crystal layer 211 and backing display 212) have been respectively mounted on the front and back face of the second housing 202, they may both be mounted together on the back face of the second housing (i.e. an arrangement of the second housing 202, liquid crystal layer 211 and backing display 212—in that order) to still provide for the same functionality. Depending on the materials used to provide for the functionality of each layer, other arrangements of the layers may also be possible.

The electrical connections of each layer are located at the top most edge of the layered assembly of the layer 211, second housing 202 and backing display 212. These are then electrically connected to the processor 205 and power supply 206 to allow the processor 205 to control said layers and to allow the power supply 206 to provide power to the respective displays. In other embodiments, each of the layers may be connected to one or more other processors or power supplies that may or may not be comprised by the overall apparatus 200.

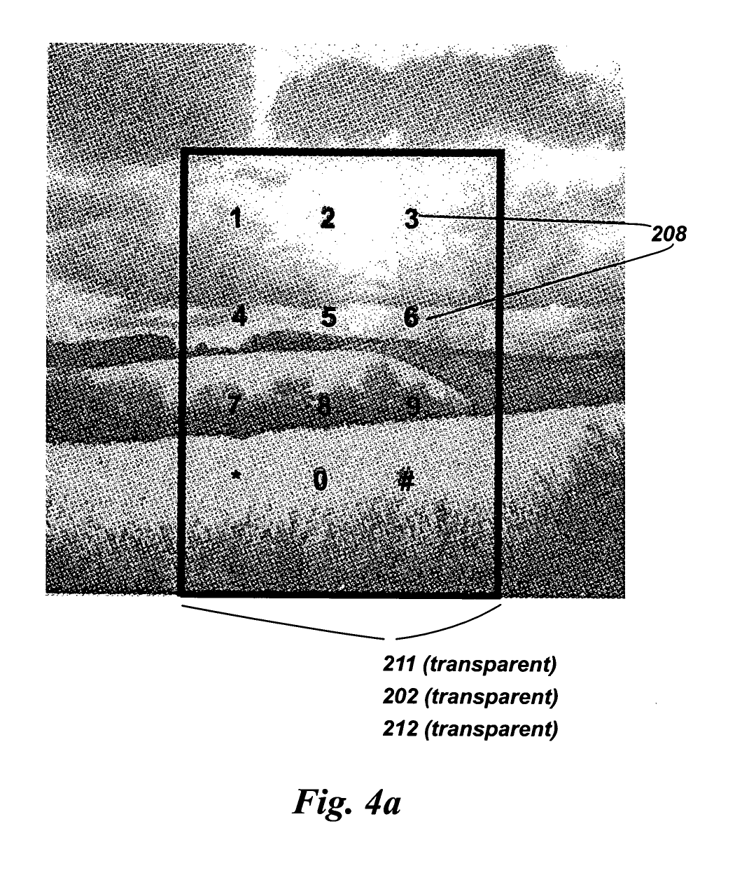

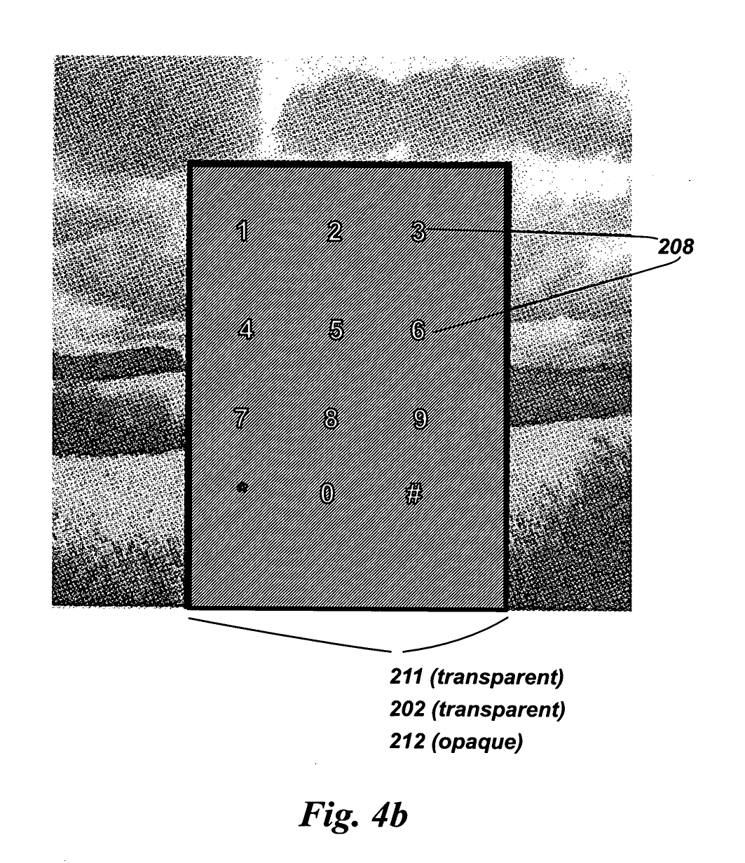

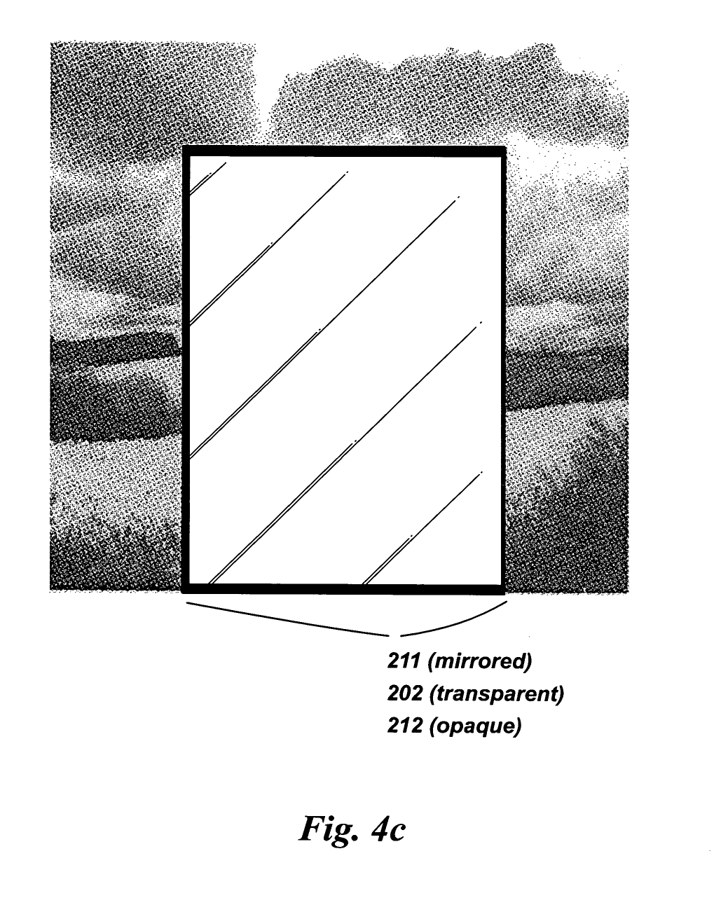

We will now describe the functionality of this embodiment with reference to FIGS. 4a-4c.

FIG. 4a illustrates the transparent mode provide by the display element in conjunction with the second housing 202. In this mode, the display element is not active. By this it is meant that both the liquid crystal layer 211 and backing display 212 adopt their optically transparent modes. As all three layers (liquid crystal layer 211, second housing 202 and backing display 212) are set to be transparent, the entire assembly appears to be optically transparent to a user. This can allow light to pass straight through the entire assembly, allowing users to view whatever is behind the assembly.

FIG. 4b illustrates the opaque mode provided by the display element in conjunction with the second housing 202. In this mode, the display element is active. By this it is meant that backing display 212 adopts its optically opaque mode. The liquid crystal layer 211 remains in its translucent state. This means that the layer 211 and second housing 202 are transparent whilst the display 212 is opaque. As a result, whilst light can pass through the liquid crystal layer 211 and the second housing 202, it cannot pass through the now opaque backing display 212. Therefore, the opaque state of the display 212 defines the total optical state of the assembly, and the assembly appears to be opaque. This prevents light passing through the entire assembly.

FIG. 4c illustrates the mirror mode provided by the display element in conjunction with the second housing 202. In this mode, the display element is active in a different way to the second opaque mode. In this mode, the liquid crystal layer 211 adopts its mirrored state to provide for reflection of incident light on its surface. The backing display 212 is set to be opaque. This means that the top most layer of the assembly (provided by the liquid crystal layer 211) appears to be a mirrored surface to provide for reflection of light. The backing display 212 is opaque to provide for a strong contrasting back surface to ensure that light from behind does not pass through the mirror from the other direction and that light from the front is strongly reflected by the mirrored liquid crystal layer. As a result, the assembly appears to be mirrored on its front surface to allow a user to utilise the assembly as a mirror.

With regard to the light emitting elements 208 of the touch panel 204/second housing 202 and the touch panel 204 functionality, these are operational in the optically transparent and optically opaque modes to allow for user input and indication of input functionality of the input area. However, in the third mirror mode, the elements 208 and touch panel 204 are not necessary to provide for the mirror mode, and may even detract from or interfere with the effectiveness of the mirroring surface (depending on the material used for this layer). In this embodiment (at least), the touch functionality of the touch panel 204 and the visual indications provided by the light emitting elements 208 are suspended/inactive to prevent such interference. This also serves to save power as the light emitting elements 208 and touch panel 204 functionality may not be required in this mode. In another embodiment, the light emitting elements 208 and touch panel 204 functionality may still be operational and active to provide for a modified user input mode, (for example, a partially mirrored surface that also allows for touch user input and visual indications of this input functionality).

It will be appreciated by a skilled person that, in other embodiments where the light emitting elements are provided by (for example) fibre optics and a light guide, or etched surfaces that are illuminated by a light source, the light emitting elements 208 may also be operated in a suitable way to allow for the separate advantages of each mode. For example, the light source may be turned on during the transparent and opaque optical modes, and may be turned off during the mirror mode to thereby ensure each mode operates correctly.

It should be noted that, in some variations of this embodiment, the backing display 212 may be omitted to provide an apparatus with just a transparent mode, and an optically mirrored mode. In other variations, the liquid crystal layer 211 may be omitted to provide an apparatus with just a transparent mode, and an optically opaque mode. In still other variations, additional layers/elements with different fixed/switchable/variable optical properties may be provided in combination with the above layers to provide the apparatus with a variety of different possible optical states.

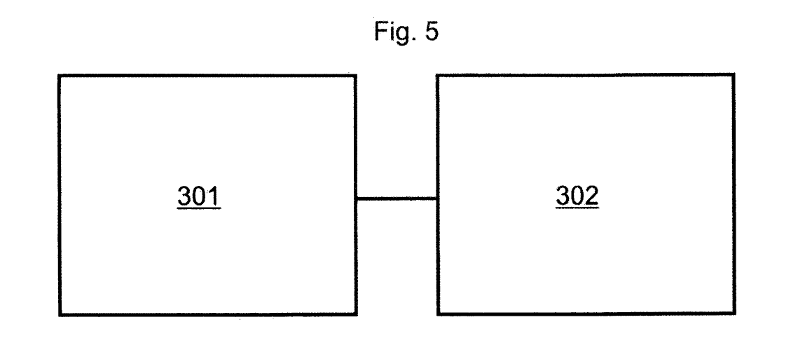

In all of the above-described embodiments, content on the display 3 and input functionality is provided by the touch panel 4. The processor 5 is responsible for controlling the operation of these components. With reference to FIG. 5, the processor is configured to:
301—control the provision of viewable user output content to the user output area; and
302—control the reception of touch user input from the user input area. The processor 5 is configured to provide user content to display 3. The processor 5 is also configured to be able to operate the touch panel 4 to provide for different types of input function/functionality. For example, the processor 5 is configured such that it is able to change the user input functions provided by the touch panel 4 from a first type (e.g. FIG. 2(ii)) to a second type (e.g. FIG. 2(iii)). This may be performed based on detected user input, or by separate operations performable by the processor (for example, the apparatus 100 may be implemented in a mobile phone, and a text may be received so a QWERTY keyboard is provided by the touch panel 4 to allow the user to reply to the text).

With regard to the above embodiments, the processor is also configured in some variations to select/apply certain optical modes or input modes (see FIGS. 2(i)-(iv) and FIGS. 4a-4c). For example, the processor may choose to operate the light emitting elements in any of these embodiments, or to apply a particular optical mode, based on received user input, or based on separate operations performable by the processor. In one particular embodiment (not shown), the processor is connected to an ambient light sensor which detects ambient light levels. The processor is configured to measure ambient light levels and select an appropriate optical mode or user input mode based on the detected ambient light levels.

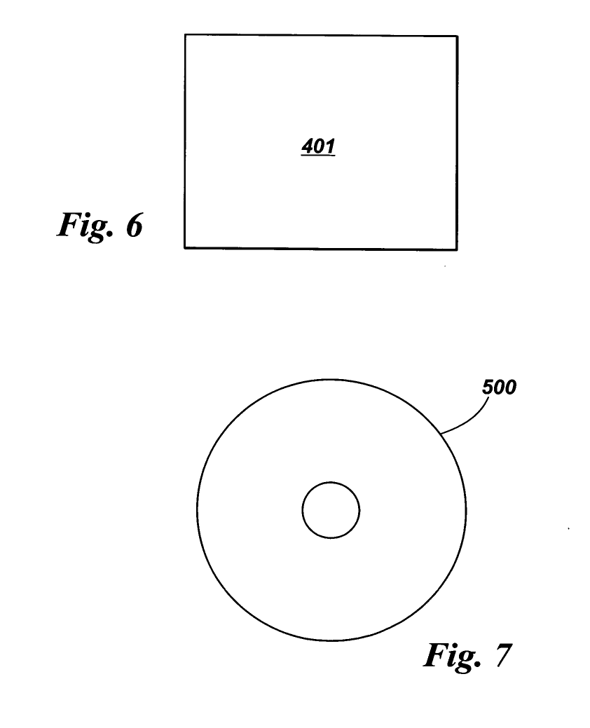

We have discussed the method of assembly of the various embodiments above. FIG. 6 illustrates a flowchart of this method of assembly. FIG. 6 shows that the apparatus is assembled using a method involving:
401—assembling the apparatus to allow the user input area, in the first configuration, to be positioned to at least partially overlie and cover the user output area to provide a covered region of the user output area, the transparent region of the user input area allowing the content on the user output area in the covered region to be viewable through the user input area, and to allow for the user input area, in the second configuration, to be positioned to be moved away from the user output area to provide a revealed region of the user output area to allow the content of the user output area in the revealed region to be directly viewable.

Other embodiments depicted in the figures have been provided with reference numerals that correspond to similar features of earlier described embodiments. For example, feature number 1 can also correspond to numbers 101, 201, 301 etc. These numbered features may appear in the figures but may not have been directly referred to within the description of these particular embodiments. These have still been provided in the figures to aid understanding of the further embodiments, particularly in relation to the features of similar earlier described embodiments.

FIG. 7 illustrates schematically a computer/processor readable media 500 providing a program according to an embodiment of the present invention. In this example, the computer/processor readable media is a disc such as a digital versatile disc (DVD) or a compact disc (CD). In other embodiments, the computer readable media may be any media that has been programmed in such a way as to carry out an inventive function.

It will be appreciated to the skilled reader that any mentioned apparatus/device/server and/or other features of particular mentioned apparatus/device/server may be provided by apparatus arranged such that they become configured to carry out the desired operations only when enabled, e.g. switched on, or the like. In such cases, they may not necessarily have the appropriate software loaded into the active memory in the non-enabled (e.g. switched off state) and only load the appropriate software in the enabled (e.g. on state). The apparatus may comprise hardware circuitry and/or firmware. The apparatus may comprise software loaded onto memory. Such software/computer programs may be recorded on the same memory/processor/functional units and/or on one or more memories/processors/functional units.

In some embodiments, a particular mentioned apparatus/device/server may be pre-programmed with the appropriate software to carry out desired operations, and wherein the appropriate software can be enabled for use by a user downloading a “key”, for example, to unlock/enable the software and its associated functionality. Advantages associated with such embodiments can include a reduced requirement to download data when further functionality is required for a device, and this can be useful in examples where a device is perceived to have sufficient capacity to store such pre-programmed software for functionality that may not be enabled by a user.

It will be appreciated that the any mentioned apparatus/circuitry/elements/processor may have other functions in addition to the mentioned functions, and that these functions may be performed by the same apparatus/circuitry/elements/processor. One or more disclosed aspects may encompass the electronic distribution of associated computer programs and computer programs (which may be source/transport encoded) recorded on an appropriate carrier (e.g. memory, signal).

It will be appreciated that any “computer” described herein can comprise a collection of one or more individual processors/processing elements that may or may not be located on the same circuit board, or the same region/position of a circuit board or even the same device. In some embodiments one or more of any mentioned processors may be distributed over a plurality of devices. The same or different processor/processing elements may perform one or more functions described herein.

With reference to any discussion of any mentioned computer and/or processor and memory (e.g. including ROM, CD-ROM etc), these may comprise a computer processor, Application Specific Integrated Circuit (ASIC), field-programmable gate array (FPGA), and/or other hardware components that have been programmed in such a way to carry out the inventive function.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the disclosure.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1. An apparatus having a first closed configuration and a second open configuration, the apparatus comprising:
a user output area configured to be able to provide viewable user output content; and
a user input area comprising a transparent region configured to be able to receive touch user input, the apparatus being configured such that:
in the first closed configuration, the transparent region of the user input area is positioned to at least partially overlie and cover the user output area to provide a covered region of the user output area, the transparent region of the user input area allowing the content on the user output area in the covered region to be viewable through the user input area; and
in the second open configuration, the user input area is positioned to be moved away from the user output area to provide a revealed region of the user output area to allow the content on the user output area in the revealed region to be directly viewable, the user input area being configured to be able to receive user input in the first and second configurations.

2. The apparatus as claimed in claim 1, wherein the apparatus is configured such that the user input area and user output area can be moved away from one another by one or more of: relative sliding, rotation, folding, or separation.

3. The apparatus as claimed in claim 1, wherein the entirety of the user input area is configured to be transparent to thereby allow the content in the covered region of the user output area to be viewable through the user input area.

4. The apparatus as claimed in claim 1, wherein the apparatus has one or more user input modes each having a set of user input functions associated with the respective mode, the apparatus being configured such that selection of a particular user input mode provides for the associated set of user input functions on the user input area.

5. The apparatus as claimed in claim 4, wherein the apparatus is configured to provide for a first and second user input mode, the apparatus also being configured such that movement of the apparatus into the first configuration causes the selection of the first user input mode to provide for a first set of user input functions on the user input area, and such that movement of the apparatus into the second configuration causes the selection of the second user input mode to provide for a second set of user input functions on the user input area.

6. The apparatus as claimed in claim 4, wherein the apparatus further comprises one or more light emitting/reflective elements configured to provide visual output indications and provided with the user input area, the set of user input functions provided by a given user input mode being visually indicated by the light emitting/reflective elements.

7. The apparatus as claimed in claim 1, wherein the apparatus is configured such that:
in the first closed configuration, the user input area may also be configured to be able to provide viewable user output content; and/or
in the second open configuration, the user output area may also configured to be able to receive touch user input.

8. The apparatus as claimed in claim 1, wherein the user input area is configured such that it is only able to receive touch user input, and/or wherein the user output area is configured such that it only provides for viewable user output content.

9. The apparatus as claimed in claim 1, wherein the apparatus is configured such that the user input area is able to control the output provided on the user output area.

10. The apparatus as claimed in claim 1, wherein the apparatus comprises a display element, the display element having a transparent state, and a non-transparent state and/or a mirror state, the display element being configured to be movable between these states, wherein the apparatus is configured such that the variable optical state of the display element can be used to change the optical state of the user input area.

11. A portable electronic device comprising the apparatus of claim 1.

12. A method of assembling an apparatus, the apparatus having a first closed configuration and a second open configuration, the apparatus comprising:
a user output area configured to be able to provide viewable user output content; and
a user input area comprising a transparent region configured to be able to receive touch user input, the apparatus being configured such that:
in the first closed configuration, the transparent region of the user input area is positioned to at least partially overlie and cover the user output area to provide a covered region of the user output area, the transparent region of the user input area allowing the content on the user output area in the covered region to be viewable through the user input area; and
in the second open configuration, the user input area is positioned to be moved away from the user output area to provide a revealed region of the user output area to allow the content on the user output area in the revealed region to be directly viewable the user input area being configured to be able to receive user input in the first and second configurations, the method comprising:
assembling the apparatus to allow the user input area, in the first configuration, to be positioned to at least partially overlie and cover the user output area to provide a covered region of the user output area, the transparent region of the user input area allowing the content on the user output area in the covered region to be viewable through the user input area, and to allow for the user input area, in the second configuration, to be positioned to be moved away from the user output area to provide a revealed region of the user output area to allow the content of the user output area in the revealed region to be directly viewable.

13. A computer readable medium comprising code stored thereon, the computer code being configured to, when run on a computer, perform the method of controlling an apparatus, the apparatus having a first closed configuration and a second open configuration, the apparatus comprising:
a user output area configured to be able to provide viewable user output content; and
a user input area comprising a transparent region configured to be able to receive touch user input, the apparatus being configured such that:
in the first closed configuration, the transparent region of the user input area is positioned to at least partially overlie and cover the user output area to provide a covered region of the user output area, the transparent region of the user input area allowing the content on the user output area in the covered region to be viewable through the user input area; and
in the second open configuration, the user input area is positioned to be moved away from the user output area to provide a revealed region of the user output area to allow the content on the user output area in the revealed region to be directly viewable, the user input area being configured to be able to receive user input in the first and second configurations, the method comprising:
controlling the provision of viewable user output content to the user output area; and
controlling the reception of touch user input from the user input area.
